(19) United States
(12) Patent Application Publication
(10) Pub. No.: US 2024/0043293 A1
(43) Pub. Date: Feb. 8, 2024

(54) Electrochemical Reduction Reactor, and System and Method Comprising Same

(71) Applicant: ACLARITY, INC, Mansfield, MA (US)

(72) Inventor: Orren David Schneider, Plainsboro, NJ (US)

(21) Appl. No.: 18/365,156

(22) Filed: Aug. 3, 2023

Related U.S. Application Data
(60) Provisional application No. 63/394,815, filed on Aug. 3, 2022.

(51) Int. Cl. C02F 1/461; C02F 1/467; C02F 1/68; C02F 1/00

(52) U.S. Cl. CPC C02F 1/46109; C02F 1/4676; C02F 1/683; C02F 1/001; C02F 2001/46142; C02F 2001/46171; C02F 2001/46161; C02F 2201/46115; C02F 2201/4618; C02F 2101/108

(57) ABSTRACT

An electrochemical reduction system includes an electrochemical reduction reactor. The electrochemical reduction reactor includes a housing having an internal fluid flow-path. A cathode having an outer, reducing, reactive surface is disposed within the internal fluid flow-path. An anode having an outer, oxidizing, reactive surface is also disposed within the internal fluid flow-path. At least portions of the cathode outer, reducing, reactive surface and the anode outer, oxidizing, reactive surface are separated by an electroactive gap.

### CROSS REFERENCE TO RELATED APPLICATIONS

This application claims the benefit under 35 U.S.C. § 119(e) of U.S. provisional application Ser. No. 63/394,815, filed on Aug. 3, 2022, the entire disclosure of which is hereby incorporated by reference.

### FIELD OF THE DISCLOSURE

The disclosure relates to liquid purification devices and more specifically to an electrochemical reduction reactor for treating contaminants in a liquid.

### BACKGROUND

With increasing occurrence of various microorganisms and anthropogenic pollutants in the environment, access to clean drinking water is a growing concern around the world. The quality of water available for potable use varies greatly depending on the source and active treatment processes. Varying characteristics of source waters make treatment processes difficult to control, let alone standardize. For example, various contaminants found in source waters have a range of differing properties, which dictate the type of treatment process used for removal or destruction (i.e., physical, biological, or chemical). As a result, the majority of commercialized water treatment systems do not have the physical and/or chemical capabilities to treat different water sources because the specific functionalities implemented for their specific source water may not be effective for other water sources (or even as quality changes occur in the targeted source(s)). Recent technologies have emerged involving advanced oxidation processes that produce hydroxyl radicals to cause degradation of many organic (and some inorganic) contaminants present in the water. However, these oxidation technologies are not effective for treating all contaminants; an entire class of organic and inorganic contaminants have not and cannot be addressed using such processes. These include compounds that are already partially or completely oxidized including poly- or perfluorinated alkyl substances (PFAS), as well as nitrate (NO₃⁻) and perchlorate (ClO₄⁻) ions. At present, these oxidized contaminants are treated by deionization (using membranes or ion exchange) or biologically using plants, fungi, and/or bacteria. Deionization, while effective, suffers from the production of high strength waste streams, which require disposal. Biological treatment can be difficult to control, let alone accelerate, especially in cold water, and results in production of waste solids (sludge), which also require disposal and/or further remediation.

### SUMMARY OF THE DISCLOSURE

According to one example, an electrochemical reduction reactor includes a housing having an internal fluid flow-path. A cathode having an outer, reducing, reactive surface is disposed within the internal fluid flow-path. An anode having an outer, oxidizing, reactive surface is also disposed within the internal fluid flow-path. At least portions of the anode outer, oxidizing, reactive surface and the cathode outer, reducing, reactive surface are separated by an electroactive gap. The oxidizing, reactive, outer surface of the anode is elemental titanium metal, and the reducing, reactive, outer surface of the cathode is Ti₄O₇. The oxidizing, reactive, outer surface of the anode is adapted and arranged such that it does not create oxidant species or minimizes creation of oxidant species.

According to another example, an electrochemical reduction system includes an electrochemical reduction reactor. The electrochemical reduction reactor comprises a housing having an internal fluid flow-path. A cathode having an outer, reducing, reactive surface is disposed within the internal fluid flow-path. An anode having an outer, oxidizing, reactive surface is also disposed within the internal fluid flow-path. At least portions of the cathode outer, reducing, reactive surface and the anode outer, oxidizing, reactive surface are separated by an electroactive gap. A source for an oxidant scavenger is fluidly connected to the internal fluid flow-path. The oxidant scavenger is capable of reacting with oxidants generated at the outer, oxidizing, reactive surface of the anode.

The foregoing example of an electrochemical reduction reactor may further include any one or more of the following optional features, structures, and/or forms.

In some optional forms, the source of an oxidized contaminant for reduction includes a contaminant chosen from one or more contaminants in the group of nitrate, nitrite, chlorate, perchlorate, poly or perfluorinated alkyl substances (PFAS), polychlorinated biphenyl (PCBs), other halogenated organic compounds, hexavalent chromium containing contaminants, orthophosphates, polyphosphates, and borate.

In other optional forms, an ion exchange membrane is disposed at least partially between the anode and the cathode, within the internal fluid flow-path.

In yet other optional forms, the cathode is cylindrically-shaped and the anode is annularly-shaped, the anode being concentrically arranged around the cathode, and a longitudinal axis of the anode and a longitudinal axis of the cathode are substantially co-linear.

In yet other optional forms, the cathode comprises a hollow cylinder comprising a porous material.

In yet other optional forms, the anode is in the form of a substantially flat plate and the cathode is in the form of a substantially flat plate.

In yet other optional forms, an oxidant scavenger is fluidly connected to the internal fluid flow-path.

In yet other optional forms, the oxidant scavenger is chosen from one or more oxidant scavengers in the group of sulfur dioxide, sodium bisulfite, potassium bisulfite, calcium bisulfite, sodium metabisulfite, potassium metabisulfite, sodium thiosulfate, potassium thiosulfate, calcium thiosulfate, and ascorbic acid.

In yet other optional forms, a filter is fluidly connected to the internal fluid flow-path and downstream of the electroactive gap, the filter being configured to capture precipitates formed by reduction reactions carried out by the electrochemical reduction reactor.

In yet other optional forms, the precipitates comprise one or more insoluble compounds in the group of boron-containing compounds, phosphorous-containing compounds, and chromium-containing compounds.

In yet other optional forms, a power supply is electrically coupled to the anode and to the cathode, such that electrons flow from the anode to the cathode.

In yet other optional forms, a voltage regulator is electrically coupled to the power supply, the voltage regulator controlling a voltage of the power supply to minimize production of oxidants, including oxygen gas, from forming at the anode.

According to yet another example, a method of treating water includes providing an electrochemical reactor including a cathode having an outer, reducing, reactive surface disposed within an internal fluid flow-path; and an anode having an outer, oxidizing, reactive surface disposed within the internal fluid flow-path. At least portions of the cathode outer, reducing, reactive surface and the anode outer, oxidizing, reactive surface are separated by an electroactive gap. A power supply is connected to the cathode and to the anode such that electrons flow from the cathode to the anode. A voltage regulator is connected to the power supply. A fluid containing an oxidized contaminant is passed through the electroactive gap. The oxidized contaminant is reduced at or near the cathode outer, reducing, reactive surface. The voltage applied by the power supply is controlled with the voltage regulator.

The foregoing example of a method of treating water may further include any one or more of the following optional features, structures, method steps, and/or forms.

In one optional form, an oxidant scavenger is added to the fluid containing an oxidized contaminant to chemically reduce any oxidant formed at the anode outer, oxidizing, reactive surface.

In another optional form, turbulence is created within the fluid flow-path, within the electroactive gap, or both, to enhance mixing and reduction of the oxidized contaminants at the cathode outer, reducing, reactive surface.

In yet another optional form, voltage is controlled by a voltage regulator to minimize the formation of oxidants at the anode outer, oxidizing, reactive surface.

In yet another optional form, an ion exchange membrane is disposed at least partially between the anode and the cathode, within the internal fluid flow-path, prior to passing the fluid containing the oxidized contaminant through the electroactive gap.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawings.

FIG. 1 is a schematic drawing of an electrochemical reduction reactor system.

FIG. 2 is an exploded perspective view of an electrochemical reduction reactor that may be used in the electrochemical reduction reactor system of FIG. 1.

FIG. 3 is a side view of the electrochemical reduction reactor of FIG. 2.

FIG. 4 is side cross-sectional view of the electrochemical reduction reactor of FIG. 2.

FIG. 5 is a close-up side cross-sectional view of an inlet cap of the electrochemical reduction reactor of FIG. 2.

FIG. 6 is a close-up side cross-sectional view of an outlet cap of the electrochemical reduction reactor of FIG. 2.

FIG. 7A and 7B are top and cross-sectional schematic views, respectively, of an alternate embodiment of an electrochemical reduction reactor that may be used in the electrochemical reduction reactor system of FIG. 1.

FIG. 8A and 8B are cross-sectional schematic views, respectively, of yet another alternate embodiment of an electrochemical reduction reactor that may be used in the electrochemical reduction reactor system of FIG. 1.

### DETAILED DESCRIPTION

The electrochemical reduction reactors described herein are advantageously used for treatment of water including, but not limited to, producing potable water, treating municipal wastewater, treating commercial wastewater, treating domestic wastewater, and/or treating industrial wastewater. More specifically, the disclosed electrochemical reduction reactors and systems described herein can be advantageously used to purify various types of water including wastewater (e.g., domestic wastewater, commercial wastewater, municipal wastewater, industrial wastewater), rain water, lake water, river water, ground water, for multiple end uses, and most significantly, to purify water intended for drinking.

Electrochemical reactors for treating water work on their intended target contaminants by causing oxidation reactions to occur at the anode and/or reduction reactions to occur at the cathode. These redox reactions are intrinsically linked to one another in that each electron essentially flows from the anode oxidizing, reactive, outer surface to the cathode reducing, reactive, outer surface. Said another way, for each substance that is reduced, another substance must be oxidized, said oxidized substance potentially creating, in situ, in the electrochemical reactor, oxidants capable of reacting with any reduced species including reduced species that can reform the oxidized substances that are intended to be (successfully) treated, remediated, or destroyed. Typically, both oxidation and reduction reactions are considered to be desirable, or at least innocuous, in electrochemical reactors as both oxidation and reduction reactions can facilitate degradation of target contaminants. The inventors have surprisingly and advantageously found that minimizing, reducing, and/or otherwise controlling oxidation reactions, particularly oxidant levels attributable to oxidation reactions occurring at an outer, oxidizing, reactive surface of the anode, within the electrochemical reduction reactors, is particularly important for some of the electrochemical reduction reactors described herein to accomplish effective, efficient reduction of contaminants, especially effective, efficient reduction of nitrates. Otherwise, the inventors have surprisingly found that significant reoxidation of the reduced contaminants is prone to occur in the electrochemical reduction reactors described herein.

The electrochemical reduction reactors described herein are durable and scalable to meet relatively small personal or domestic demands as well as relatively large consumer, commercial, municipal, or industrial demands. Advantageously, the electrochemical reduction reactors described herein can be manufactured without moving parts and therefore have long useful lives, while being relatively inexpensive and easy to manufacture. Moreover, the electrochemical reduction reactors described herein surprisingly and unexpectedly can more efficiently treat/destroy contaminants present in the water/solution being treated, with significantly less waste being produced and with a simplicity of operation, particularly relative to existing systems that treat water including contaminants using advanced oxidation processes.

As used herein, the term “electrochemical reduction reactor” refers to a reactor in which the working electrode is the cathode. Said another way, the contaminants to be treated are reduced at the cathode rather than oxidized at the anode.

As used herein, an electrochemical reduction reactor refers to a reactor having a solution or fluid flow-path there through. The basic structural elements of an electrochemical reduction reactor include a housing having an inlet, an outlet, one or more anodes, and one or more cathodes, as described and shown for example in US Patent Publication No. 2019/0284066, and in U.S. Patent Publication No. 2022/0073380, each of which are hereby incorporated by reference in their entirety. While the current flow in the electrochemical reactor exemplified in US Patent Publication No. 2019/0284066 and U.S. Patent Publication No. 2022/0073380 can be reversed, such that the electrochemical reactor is rearranged to effect reduction of contaminant species, the present inventors surprisingly found that, for some contaminants, such operation was found to be undesirable and/or substantially inoperable, as the overall reduction efficiency was poor, as measured, for example, by a percentage of reduced species to oxidized substances or that for some electrodes, e.g., stainless steel, significant corrosion of the materials occurred.

The disclosed electrochemical reduction reactors utilize electricity to effect water purification and/or contaminant destruction. Specifically, contaminants, such as oxidized substances, are reduced on or near the cathode surface, which destroys the contaminants. Surprisingly, oxidized contaminants such as nitrate, nitrite, chlorate, perchlorate, poly or perfluorinated alkyl substances (PFAS), polychlorinated biphenyl (PCBs), other halogenated organic compounds, hexavalent chromium containing contaminants, orthophosphates, polyphosphates, and borate can be efficiently and rapidly reduced on or near the cathode surface of the disclosed electrochemical reduction reactors, thereby transforming these unwanted contaminants to less harmful substances. Further, the electrodes employed are not consumed by the reactions, which drastically minimizes the maintenance requirements as well as the cost of replacement. As a result, fouling or scaling of the electrodes by agglomeration of organic matter, or by precipitation of metals, can advantageously be reversed by reversing the polarity of the electrodes, backwashing with water, increasing voltage, and/or by cleaning with an acid or base.

“About,” “approximately,” or “substantially” as used herein are inclusive of the stated value and means within an acceptable range of deviation for the particular value as determined by one of ordinary skill in the art, considering the measurement in question and the error associated with measurement of the particular quantity (i.e., the limitations of the measurement system). For example, “about,” “approximately,” or “substantially” can mean within one standard deviation, or within ±10%, 5%, 3%, or 1% of the stated value.

“Carbonaceous” as used herein means a material that comprises carbon. To be considered “carbonaceous” as used herein, a material should contain carbon with carbon atoms in other than a +4 oxidation state (such that the carbon atoms are capable of being oxidized). For example, carbonaceous materials include, but are not limited to, graphite, graphene, fullerenes, electrically conductive plastics, and diamond.

In order for an electrochemical process (and thus for the disclosed electrochemical reduction reactors) to operate, there must be two (or more) electrodes, generally opposed to one another with one or more functioning as an anode and one or more functioning as a cathode. “Electroactive gap” as used herein refers to a gap or space between corresponding pairs of electrodes functioning as the anode(s) and the cathode(s). In the disclosed flow-through electrochemical reduction reactors, the electroactive gap is provided in the flow-path through which the solution, typically an aqueous phase including contaminants, typically oxidized substances, to be treated and/or destroyed, may flow and electrons may be transferred when the electrodes of the electrochemical reactors are powered. The disclosed flow-through electrochemical reduction reactors are adapted and arranged such that the current flow causes reducing reactions to take place within the electroactive gap that cause contaminants in the water/solution being treated to degrade and/or be rendered inactive, thereby purifying the water and even converting non-potable water to potable water and/or allowing the effluent stream to be released to the environment.

“Dimensionally stable anode” as used herein (and as conventionally understood) refers to an anode that displays relatively high conductivity and corrosion resistance. Generally, dimensionally stable anodes are manufactured from one or more metal oxides such as RuO₂ (ruthenium oxide), IrO₂ (iridium oxide), SnO (tin oxide) and/or PtO₂ (platinum oxide).

“Mixed metal oxide electrodes” as used herein (which may, in certain embodiments disclosed herein, be used as the anode or as the cathode) are made by coating a substrate, such as a titanium plate or an expanded mesh, with a mixture of metal oxides. One of the oxides present is usually RuO₂ (ruthenium oxide), IrO₂ (iridium oxide), SnO (tin oxide) or PtO₂ (platinum oxide), for conducting electricity and catalyzing the desired reactions.

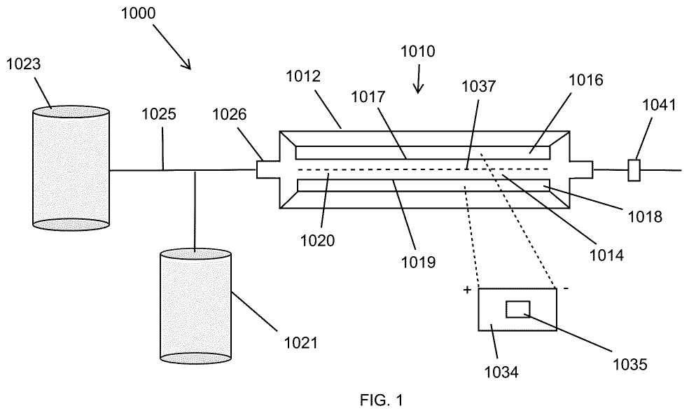

Turning now to FIG. 1, an electrochemical reduction system 1000 includes an electrochemical reduction reactor 1010. The electrochemical reduction reactor 1010 comprises a housing 1012 having an internal fluid flow-path 1014. A cathode 1016 having an outer, reducing, reactive surface 1017 is disposed within the internal fluid flow-path 1014. An anode 1018 having an outer, oxidizing, reactive surface 1019 is also disposed within the internal fluid flow-path 1014. At least portions of the cathode 1016 outer, reducing, reactive surface and the anode 1018 outer, oxidizing, reactive surface are separated by an electroactive gap 1020 between the anode 1018 and the cathode 1016. In some embodiments, the electroactive gap 1020 is less than 25 cm and greater than 1 cm. In other embodiments, the electroactive gap is greater than 2 mm and less than 5 mm, for example, about 3 mm.

In the illustrated embodiment, a source for an oxidant scavenger 1021 is fluidly connected to the internal fluid flow-path 1014. The oxidant scavenger 1021 is advantageously capable of reacting with any oxidants generated at the outer, oxidizing, reactive surface 1019 of the anode 1018. In general, the inventors surprisingly found that minimizing, decreasing, and/or otherwise controlling oxidant levels is particularly important for the electrochemical reduction reactors described herein to carry out effective, efficient reduction of oxidized substances or contaminants. Otherwise, significant reoxidation of numerous reduced contaminant species is prone to occur, especially because of the relatively small dimension of the electroactive gap typically used in the electrochemical reduction reactors described herein.

In some embodiments, the oxidizing, reactive, outer surface 1019 of the anode 1018 is elemental titanium metal (e.g., not including any exterior facing coating), and the reducing, reactive, outer surface 1017 of the cathode 1016 is Ti₄O₇. When this specific selection of materials is combined and the anode and cathode are structured and arranged as disclosed, oxidant formation at the anode can surprisingly and advantageously be minimized, such that addition of oxidant scavengers is optional. Advantageously, when combined and arranged as described, the oxidizing, reactive, outer surface 1019 of the anode 1018 does not create oxidant species, or minimizes creation of oxidant species (typically, chlorine gas, hypochlorous acid, or reactive oxygen species), which again can be disadvantageous because these oxidant species can cause re-oxidation of reduced contaminant species to occur, as will be discussed further below. Additionally, when added, the oxidant scavenger 1021 chemically reduces any oxidant species that are created (typically, chlorine gas, hypochlorous acid, or reactive oxygen species) at the oxidizing, reactive, outer surface 1019 of the anode 1018 to prevent re-oxidation of species previously reduced at the cathode surface. In some embodiments, when the amount of oxidant species present/created at the anode surface is minimal, typically because of the specific selection and arrangement of anode and cathode as disclosed above and/or the voltage is controlled as described below, the oxidant scavenger 1021 may be omitted. When employed, the oxidant scavenger may be chosen from one or more in the group of sulfur dioxide, sodium bisulfite, potassium bisulfite, calcium bisulfite, sodium metabisulfite, potassium metabisulfite, sodium thiosulfate, potassium thiosulfate, calcium thiosulfate, and ascorbic acid.

An oxidized contaminant 1023 for reduction is fluidly connected to the electrochemical reduction reactor 1010 by an input line 1025 that is fluidly connected to a reactor inlet 1026. The oxidized contaminant 1023 for reduction includes a contaminant chosen from one or more contaminants in the group of nitrate, nitrite, chlorate, perchlorate, poly or perfluorinated alkyl substances (PFAS), polychlorinated biphenyl (PCBs), other halogenated organic compounds, hexavalent chromium containing contaminants, orthophosphates, polyphosphates, and borate.

Optionally, an ion exchange membrane 1037 may be disposed at least partially between the anode 1018 and the cathode 1016, within the internal fluid flow-path 1014. In some embodiments, the ion-exchange membrane 1037 comprises a cationic exchange membrane. The cationic exchange membrane allows only cations to cross the membrane, but not anions or uncharged species. For example, when reducing nitrate, nitrite is formed, which is very susceptible to reoxidation. The cationic exchange membrane prevents the nitrite from crossing over to relative closer proximity to the anode, thereby preventing the nitrite from reoxidizing to nitrate at the anode, or more likely, because of reaction with an oxidant generated at the anode. The ion-exchange membrane 1037 is thus generally positioned to segregate any oxidant formed at the oxidizing, reactive, outer surface 1019 of the anode 1018, from reaching reduced species produced at the reducing, reactive, outer surface 1017 of the cathode 1016. Consequently, any oxidant formed at the anode advantageously does not interfere with reducing reactions occurring at or near the reducing, reactive, outer surface 1017 of the cathode 1016. As a representative example, nitrites are typically formed as nitrates are reduced at the cathode. Nitrites can be (re)oxidized to form nitrates upon coming into contact with oxidants generated at the anode surface. By providing the ion exchange membrane 1037, typically formed oxidant species, including but not limited to chlorine gas, hypochlorous acid, and reactive oxygen species, which can otherwise react with and reoxidize (partially) reduced species such as nitrites, can advantageously be segregated on one side of the ionic exchange membrane 1037 thereby effectively enhancing the overall conversion efficiency of the electrochemical reduction system 1000.

In some embodiments, such as the embodiment illustrated in FIG. 1, either the anode 1018 or the cathode 1016 may be in the form of a substantially flat plate, or both the anode 1018 and the cathode 1016 may be in the form of a substantially flat plate. In other embodiments, the anode 1018 and the cathode 1016 may take other shapes, such as concentric cylinders, as described below.

Optionally, a filter 1041 may be fluidly connected to the internal fluid flow-path 1014 and downstream of the electroactive gap 1020. The filter 1041 may be configured to capture precipitates formed by reduction of the oxidized contaminants carried out by the electrochemical reduction system 1000 at or near the reducing, reactive, outer surface 1017 of the cathode 1016. Some examples of precipitates captured by the filter 1041 may include one or more compounds in the group of boron compounds, phosphorous compounds, and chromium compounds.

In some embodiments, an optional pre-filter (not shown) may be installed upstream of electrodes, the pre-filter may capture particles or various inorganic or organic materials thereby preventing the particles from creating potentially short circuiting bridges between electrodes.

Among the possible reactions that may occur, several are of specific importance for providing effective industrial, municipal, domestic, and/or potable water treatment capabilities capable of reducing oxidized contaminants. These include the stepwise reduction of nitrate (NO₃⁻) to nitrite (NO₂⁻) and then to either nitrogen gas (N₂) or ammonia/ammonium (NH₃/NH₄⁺) and the reduction of perchlorate ion (ClO₄⁻) to chloride ion (Cl⁻). In addition, destruction of poly- and perfluorinated alkyl substances (PFAS) and polychlorinated biphenyls (PCBs) to carbon dioxide and chloride and fluoride ions may also be accomplished in an electrochemical reduction system 1000.

A power supply 1034 is electrically coupled to the anode 1018 and to the cathode 1016, such that electrons flow from the anode 1018 to the cathode 1016. The power supply 1034 can be operated in any fashion, for example, at a substantially constant voltage or at a substantially constant amperage. Whereas most electrochemical systems operate in constant amperage mode, such that the voltage is allowed to vary as the conductivity of the water changes, the electrochemical reduction reactors described here preferably are advantageously operated in a substantially constant voltage mode to limit oxidant formation. Thus, as illustrated, an optional voltage regulator 1035 may be electrically coupled to the power supply 1034. The voltage regulator 1035 controls voltage of the power supply 1034 to minimize production of oxidants at the anode 1018. The voltage regulator 1035 may be integrally formed with the power supply 1034, or the voltage regulator 1035 may be a separate element operationally connected to the power supply 1034. Generally, the inventors have found that the voltage regulator 1035 must operate the electrochemical reduction reactor at a voltage less than the anode overpotential plus 1.23V (i.e., the potential for electrolysis of water). For example, the voltage can be set in a range between 1.20 volts and about 3.70 volts, for example, between about 1.80 volts and about 3.40 volts. Of course, the controlled voltage operation range can change based on numerous system parameters including but not limited to the specific electrodes, pH concentration, and the electrolyte concentration, as well as the target contaminant that is intended to be remediated with the electrochemical reduction reactor.

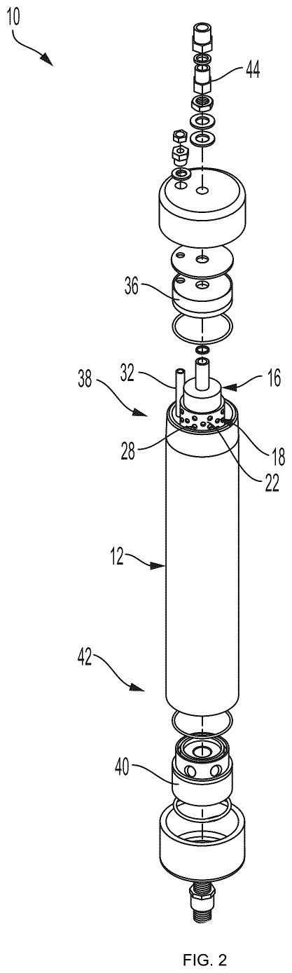

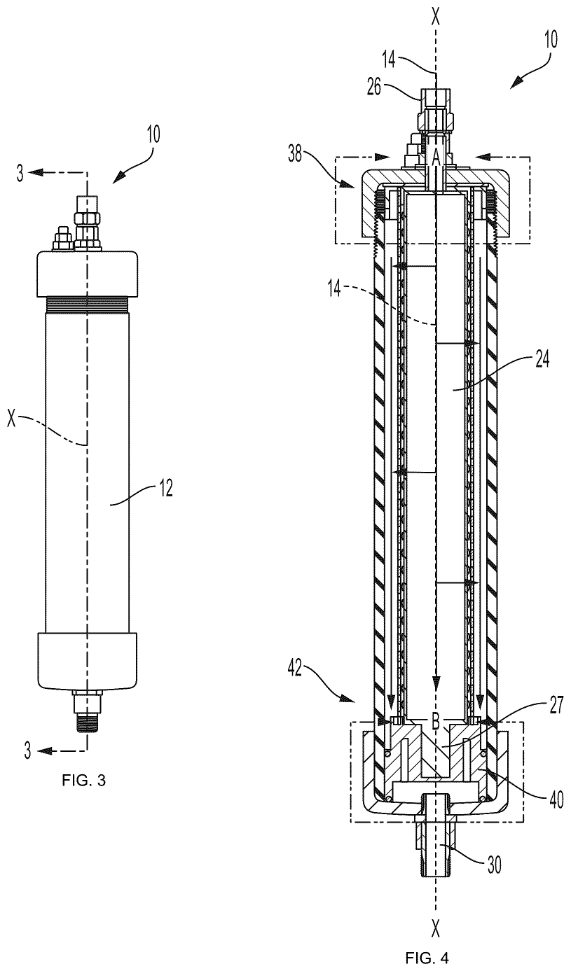

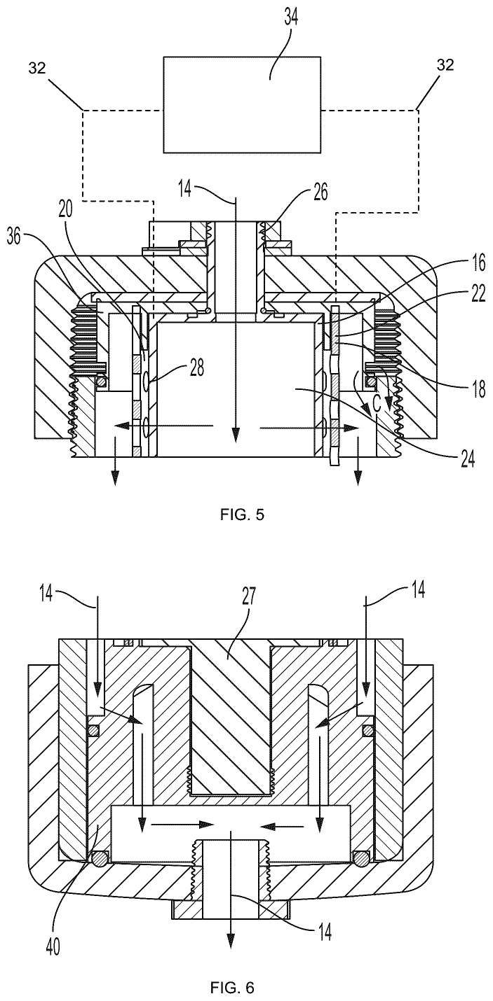

Turning now to FIGS. 2-6, an additional exemplary electrochemical reduction reactor is illustrated that may be used in the electrochemical reduction system 1000 of FIG. 1 in lieu of or in combination with electrochemical reduction reactor 1010. Other examples of electrochemical reduction reactors described herein may also be used as alternatives in the electrochemical reduction system 1000 of FIG. 1.

Referring again to FIGS. 2-6, the illustrated electrochemical reduction reactor 10 includes a housing 12 having a fluid flow-path 14. A flow-through or solid first electrode, such as a cathode 16, is disposed within the fluid flow-path 14. In the illustrated embodiment, the cathode 16 is annulus-shaped and comprises a hollow cylinder, comprising a porous material or perforations or apertures. Such modified cathodes 16 can advantageously permit radial flow within the housing 12.

A second electrode, such as an anode 18, is spaced apart from the cathode 16, thereby creating an electroactive gap 20 between the anode 18 and the cathode 16. In some embodiments, the electroactive gap 20 is less than 5 mm and greater than 2 mm. For example, in some embodiments, the electroactive gap is about 3 mm. In the illustrated embodiment, the anode 18 is concentrically arranged about the cathode 16. In embodiments where the anode 18 or the cathode 16 comprise porous walls, the porous wall can be provided by a cylinder comprising a porous material or by a cylinder with perforations or apertures as shown in the illustrated embodiment. In both instances, radial flow through the anode 18 is possible. As mentioned above, the concentric arrangement of the anode 18 and the cathode 16 may also be reversed.

In some other embodiments, for example, where an ion-exchange membrane 1037 is disposed in the electroactive gap 20, the electroactive gap may be larger, for example, between 1 cm and 25 cm.

As illustrated in FIGS. 2-6, both the anode 18 and the cathode 16 have a hollow cylindrical shape. The anode 18 and the cathode 16 are arranged concentrically, the cathode 16 being located within a cylindrical wall 22 of the anode 18. The arrangement illustrated in FIGS. 2-6 is particularly useful as a reducing reactor. In the illustrated embodiment of FIGS. 2-6, the concentrically arranged anode 18 and cathode 16 share a common longitudinal axis x. An interior 24 of the cathode 16 forms an initial flow-path for the water/solution to be treated that enters the housing 12 through an inlet 26. As the water/solution to be treated fills the interior 24, it flows longitudinally, parallel to the longitudinal axis x and eventually reaches the bottom of the interior 24 where the liquid is stopped by a plug 27. Once stopped, pressure builds up in the interior 24, which forces the liquid to flow radially outward, perpendicular to the longitudinal axis x, and over the wall of the cathode 16 such that it can now access the electroactive gap 20 between the anode 18 and the cathode 16. The liquid may pass through the wall of the anode 18 through porous openings in the anode 18, or through apertures or perforations in the anode 18, allowing treated fluid to be appropriately directed via an outlet 30.

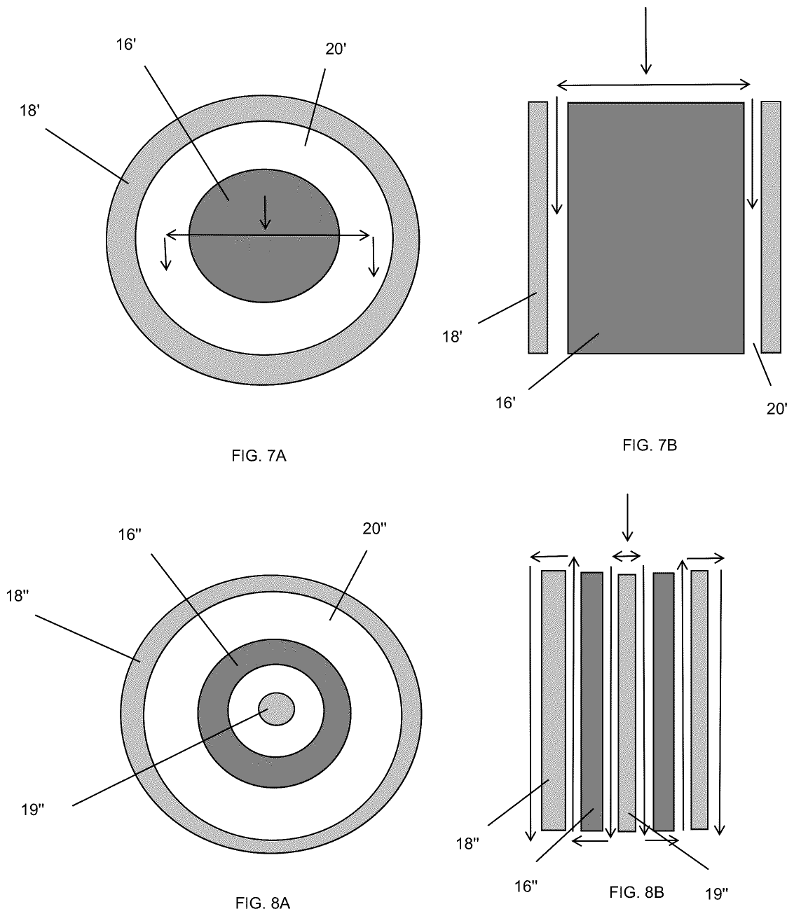

In other embodiments, for example as illustrated in FIGS. 7A and 7B, the cathode 16′ comprises a solid cylinder, as the liquid enters through the inlet (not shown in FIGS. 7A and 7B), the fluid flows (represented by arrows in FIGS. 7A and 7B) over an outer surface of the cathode cylinder 16′, thereby accessing the electroactive gap 20′ between the outer surface of the cathode 16′ (which serves as an outer, reducing, reactive surface) and an inner surface of the anode 18′ (which serves as an outer, oxidizing, reactive surface) proximate to the inlet. Thereafter, the liquid flows between the anode 18′ and the cathode 16′, through the electroactive gap 20′.

In yet other embodiments, for example as illustrated in FIGS. 8A and 8B, the cathode 16″ comprises a hollow cylinder with a solid wall, a first anode 18″ comprising a hollow cylinder with a solid wall is disposed concentrically and outside of the cathode 16 and a second anode 19″ optionally disposed within the hollow annular space defined by the cathode 16″ solid wall. In this embodiment, the liquid flows (represented by the arrows in FIGS. 8A and 8B) across the top of the second anode 19″, then downward, through the hollow annular space of the cathode 16″ between the solid cathode 16″ wall and the second anode 19″ until reaching a bottom of the interior, where the liquid is stopped and forced to flow laterally outwards around a bottom end of the solid cathode 16″ wall and then upwards through the electroactive gap between an outer surface of the solid cathode 16″ wall (which serves as an outer, reducing, reactive surface) and an inner surface of the first anode 18″ (which serves as an outer, oxidizing, reactive surface). The fluid may then be collected and/or otherwise directed for further treatment and/or use. Optionally, the fluid flow may further continue around a top of the first anode 18″ and then downwardly to the bottom of the electrochemical reduction reactor as illustrated in FIG. 8B.

Regardless, in the illustrated embodiments, once the liquid flows through, over, and/or around the wall of the cathode 16, 16′, 16″, the liquid will be in the electroactive gap 20. When in the electroactive gap 20, chemical reactions take place in the liquid, which are driven by the electron flow supplied by the powered anode 18, 18′, 18″ and cathode 16, 16′, 16″. In this case, the chemical reactions are primarily reducing in nature (although oxidation reactions may also occur, these are favorably mitigated, controlled, and/or minimized as discussed variously throughout this disclosure). The liquid continues to flow between the anode 18, 18′, 18″ wall 22 and the cathode 16, 16′, 16″ wall. Eventually, the liquid flows out of the electroactive gap 20, such that the treated liquid can be collected and/or otherwise directed for further treatment and/or use.

In embodiments, both the anode 18, 18′, 18″ and the cathode 16, 16′, 16″ may comprise solid cylindrical walls. Referring again specifically to FIGS. 2-6, the solution flow-path may enter the hollow interior of the cathode 16, flow downward until contacting the plug 27, then around a bottom end of the cathode 16, through a gap between a bottom of the cathode 16 wall and the plug 27, then upward through the electroactive gap 20 between the cathode 16 and anode 18 until contacting an inlet cap 36 and through a gap between the inlet cap 36 and the top end of the anode 18, then downward on the outside of the anode 18 to the outlet.

A power source 34 is connected to the anode 18 and to the cathode 16 via an electrical connection 32. The power source 34 ultimately supplies DC power to the cathode 16 and to the anode 18. The power source 34 may directly supply DC power, or the power source 34 may convert AC power to DC, for example with a transformer rectifier, before supplying the cathode 16 and the anode 18. In use, the power source 34 charges the anode 18 and the cathode 16 and water/solution being treated fills the electroactive gap 20, such that electrons flow between the anode 18 and the cathode 16 so as to drive certain desirable chemical reactions causing primarily reduction of contaminants. The power source 34 may include, or be connected to, a voltage regulator (not shown in FIG. 2-6), as discussed above with respect to FIG. 1.

The inlet cap 36 is disposed at a first end 38 of the housing 12, the inlet cap 36 maintains proper spacing and orientation of the anode 18 relative to the cathode 16. An outlet guide flow cap 40 is disposed at a second end 42 of the housing 12. The outlet guide flow cap 40 seals the second end 42 of the housing 12 and receives outlet flow from the exterior of the cathode 16. The outlet guide flow cap 40 also seals one end of the interior 24 of cathode 16 in conjunction with the plug 27.

An adapter base inlet 44 is disposed at the first end 38 of the housing 12, the adapter base inlet 44 providing plumbing and electrical connections while maintaining a pressure seal.

The cathode 16 may comprise carbonaceous materials, dimensionally stable anodes (DSA), Magneli-phase titanium oxide (of general formula TiₙO₂ₙ₋₁, for example Ti₄O₇), mixed metal oxides (including one or more of RuO2 (ruthenium oxide), IrO2 (iridium oxide), SnO (tin oxide) and PtO2 (platinum oxide)), or boron doped diamond (BDD), or a combination thereof. As used herein, the term “Magneli-phase titanium oxide” refers to a titanium oxide having general formula TiₙO₂ₙ₋₁, for example, Ti₄O₇, Ti₅O₉, Ti₆O₁₋, or a mixture thereof. In an embodiment, the Magneli-phase titanium oxide may be Ti₄O₇. In other embodiments, the Magneli-phase titanium oxide may be a mixture of Magneli-phase titanium oxides. In a preferred embodiment, the cathode comprises Ti₄O₇ and has an outer, reducing, reactive surface of exposed Ti₄O_{7.}

The anode 18 may comprise one of elemental titanium, dimensionally stable anodes (DSA), Magneli-phase titanium oxide (of general formula TiₙO₂ₙ₋₁, for example Ti₄O₇), mixed metal oxides (such as RuO₂ (ruthenium oxide), IrO₂ (iridium oxide), SnO (tin oxide) or PtO₂ (platinum oxide)), boron doped diamond (BDD), others, or a combination thereof. In a preferred embodiment, the anode 18 comprises an oxidizing, reactive, outer surface of exposed elemental titanium.

Once an appropriate electrochemical reduction reactor is constructed and arranged, the power is applied to the cathode(s) and the anode(s), and fluid to be treated is passed through the electrodes resulting in electrochemical reduction purification thereof. The purified fluid is subsequently removed/directed/collected from the outlet of the electrochemical reduction reactor. The applied power may be reversed periodically to prevent passivation of the electrodes and to remove foulants. In other embodiments, the reactor may be periodically backwashed to purge built up solids that may have accumulated in the pores or openings of the electrode.

The electrochemical reduction reactor system, according to any embodiment, may further optionally include an oxidation-reduction potential sensor, a pH sensor, a chlorine sensor, a conductivity sensor, a flow rate sensor, a pressure sensor, a temperature sensor, one or more contaminant sensors (such as nitrogen, TOC, UV-Vis, etc.), or a combination thereof.

Some advantages for using the disclosed electrochemical reduction reactors are high corrosion resistance to acidic and basic solutions, high electrical conductivity, increased mass transfer, long electrode life, and electrochemical stability. Other advantages include easily disposable byproducts of the reactions, and small and efficient reactor systems.

In use, water treatment includes providing an electrochemical reduction reactor, such as the electrochemical reduction reactor 10, 1010 described above. Power is supplied to the cathode 16 and to the anode 18 by a power supply 34, 1034, such that electrons flow from the cathode 16 to the anode 18. The voltage regulator 1035 is operably connected to the power supply 34, 1034. A fluid containing a contaminant, such as an oxidized contaminant 1023, is passed through the electroactive gap 20, 1020. The oxidized contaminant 1023 is reduced at the cathode outer, reducing, reactive surface 1017. The voltage applied by the power supply 34, 1034 is controlled with the voltage regulator 1035.

Optionally, the oxidant scavenger 1021 is added to the fluid containing an oxidized contaminant 1023 to chemically reduce any oxidant formed at the anode outer, oxidizing, reactive surface 1019, but the oxidant scavenger 1021 can be introduced into the fluid flow-path of the electrochemical reduction reactor separately as well.

As the fluid containing the oxidized contaminant 1023 flows through the electroactive gap 20, 1020, turbulence can be advantageously created by mixing, for example with one or more paddles, within the electroactive gap 20, 1020 which enhances mixing and reduction of the oxidized contaminants at the cathode outer, reducing, reactive surface 1017.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An electrochemical reduction reactor comprising:
a housing including an internal fluid flow-path;
a cathode having an outer, reducing, reactive surface disposed within the internal fluid flow-path; and
an anode having an outer, oxidizing, reactive surface disposed within the internal fluid flow-path, at least portions of the anode outer, oxidizing, reactive surface and the cathode outer, reducing, reactive surface being separated by an electroactive gap; and
wherein the oxidizing, reactive, outer surface of the anode is elemental titanium metal and the reducing, reactive, outer surface of the cathode is Ti₄O₇, and
wherein the oxidizing, reactive, outer surface of the anode does not create a high concentration of oxidant species.

2. The electrochemical reduction reactor of claim 1, further comprising a source of an oxidized contaminant for reduction by the electrochemical reduction reactor, the source of the oxidized contaminant being fluidly connected to the internal fluid flow-path.

3. The electrochemical reduction reactor of claim 2, wherein the source of an oxidized contaminant for reduction includes a contaminant chosen from one or more in the group of nitrate, nitrite, chlorate, perchlorate, poly or perfluorinated alkyl substances (PFAS), polychlorinated biphenyl (PCBs), other halogenated organic compounds, hexavalent chromium containing contaminants, orthophosphates, polyphosphates, and borate.

4. The electrochemical reduction reactor of claim 1, further comprising an ion exchange membrane disposed at least partially between the anode and the cathode, within the internal fluid flow-path.

5. The electrochemical reduction reactor of claim 1, wherein the cathode is cylindrically-shaped and the anode is annularly-shaped and a longitudinal axis of the anode and a longitudinal axis of the cathode are substantially co-linear.

6. The electrochemical reduction reactor of claim 1, wherein the cathode comprises a solid cylinder.

7. The electrochemical reduction reactor of claim 6, wherein the solid cylinder comprises a porous material.

8. The electrochemical reduction reactor of claim 1, wherein the cathode comprises a hollow cylinder comprising a porous material.

9. The electrochemical reduction reactor of claim 1, wherein the anode is in the form of a substantially flat plate and the cathode is in the form of a substantially flat plate.

10. The electrochemical reduction reactor of claim 1, further comprising an oxidant scavenger fluidly connected to the internal fluid flow-path.

11. The electrochemical reduction reactor of claim 10, wherein the oxidant scavenger is chosen from one or more in the group of sulfur dioxide, sodium bisulfite, potassium bisulfite, calcium bisulfite, sodium metabisulfite, potassium metabisulfite, sodium thiosulfate, potassium thiosulfate, calcium thiosulfate, and ascorbic acid.

12. The electrochemical reduction reactor of claim 1, further comprising a filter fluidly connected to the internal fluid flow-path and downstream of the electroactive gap, the filter being configured to capture precipitates formed by reduction carried out by the electrochemical reduction reactor.

13. The electrochemical reduction reactor of claim 12, wherein the precipitates comprise one or more compounds in the group of boron, phosphorous, and chromium.

14. The electrochemical reduction reactor of claim 1, further comprising a power supply electrically coupled to the anode and to the cathode, such that electrons flow from the anode to the cathode.

15. The electrochemical reduction reactor of claim 14, further comprising a voltage regulator electrically coupled to the power supply, the voltage regulator controlling voltage of the power supply to minimize oxidants from forming at the anode.

16. An electrochemical reduction system comprising:
an electrochemical reduction reactor including a housing having an internal fluid flow-path, a cathode having an outer, reducing, reactive surface disposed within the internal fluid flow-path, and an anode having an outer, oxidizing, reactive surface disposed within the internal fluid flow-path, at least portions of the cathode outer, reducing, reactive surface and the anode outer, oxidizing, reactive surface being separated by an electroactive gap; and
a source for an oxidant scavenger fluidly connected to the internal fluid flow-path, the oxidant scavenger being capable of reacting with and eliminating any oxidants generated at the outer, oxidizing, reactive surface of the anode.

17. The electrochemical reduction system of claim 16, wherein the oxidant scavenger is chosen from one or more in the group of sulfur dioxide, sodium bisulfite, calcium bisulfite, sodium metabisulfite, sodium/calcium thiosulfate, and ascorbic acid.

18. The electrochemical reduction system of claim 16, further comprising a power supply electrically coupled to the anode and to the cathode, such that electrons flow from the anode to the cathode.

19. The electrochemical reduction reactor of claim 18, further comprising a voltage regulator electrically coupled to the power supply, the voltage regulator controlling voltage of the power supply to minimize oxidants from forming at the anode.

20. The electrochemical reduction system of claim 16, further comprising a filter fluidly connected to the internal fluid flow-path and downstream of the electroactive gap, the filter being configured to capture precipitates formed by reduction carried out by the electrochemical reduction reactor.

21. The electrochemical reduction system of claim 16, further comprising an ion exchange membrane disposed at least partially between the anode and the cathode, within the internal fluid flow-path.

22. The electrochemical reduction reactor of claim 16, further comprising a source of an oxidized contaminant for reduction by the electrochemical reduction reactor, the source of the oxidized contaminant being fluidly connected to the internal fluid flow-path.

23. A method of treating water, the method comprising:
providing an electrochemical reactor including a cathode having an outer, reducing, reactive surface disposed within an internal fluid flow-path; and an anode having an outer, oxidizing, reactive surface disposed within the internal fluid flow-path, at least portions of the cathode outer, reducing, reactive surface and the anode outer, oxidizing, reactive surface being separated by an electroactive gap;
connecting a power supply to the cathode and to the anode such that electrons flow from the cathode to the anode;
connecting a voltage regulator to the power supply;
passing a fluid containing an oxidized contaminant through the electroactive gap;
reducing the oxidized contaminant at the cathode outer, reducing, reactive surface; and
controlling the voltage applied by the power supply with the voltage regulator.

24. The method of claim 23, further comprising adding an oxidant scavenger to the fluid containing an oxidized contaminant to chemically reduce any oxidant formed at the anode outer, oxidizing, reactive surface.

25. The method of claim 23, further comprising creating turbulence within the electroactive gap to enhance mixing and reduction of the oxidized contaminants at the cathode outer, reducing, reactive surface.

26. The method of claim 23, wherein the voltage regulator controls voltage to minimize the formation of oxidants at the anode outer, oxidizing, reactive surface.

27. The method of claim 23, further comprising disposing an ion exchange membrane at least partially between the anode and the cathode, within the internal fluid flow-path, prior to passing the fluid containing the oxidized contaminant through the electroactive gap.

28. An electrochemical reduction reactor comprising:
a housing including an internal fluid flow-path;
a cathode having an outer, reducing, reactive surface disposed within the internal fluid flow-path;
an anode having an outer, oxidizing, reactive surface disposed within the internal fluid flow-path, at least portions of the anode outer, oxidizing, reactive surface and the cathode outer, reducing, reactive surface being separated by an electroactive gap; and
an ion exchange membrane disposed at least partially within the electroactive gap.
